(19) United States
(12) Patent Application Publication
(10) Pub. No.: US 2009/0274201 A1
(43) Pub. Date: Nov. 5, 2009

(54) ETHERNET TRANSCEIVER AND ETHERNET TRANSMISSION METHOD BASED ON COAX NETWORK

(75) Inventor: Yang Yu, Beijing (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: HANGZHOU H3C TECHNOLOGIES CO., LTD., Hangzhou City (CN)

(21) Appl. No.: 12/502,871

(22) Filed: Jul. 14, 2009

Related U.S. Application Data
(63) Continuation-in-part of application No. PCT/CN2007/002153, filed on Jul. 13, 2007.

(30) Foreign Application Priority Data
Jan. 15, 2007 (CN) 200710002385.5

(51) Int. Cl. H04B 1/38; H04J 3/16

(52) U.S. Cl. 375/219; 370/466; 375/257; 725/127

(57) ABSTRACT

An Ethernet transceiver and an Ethernet transmission method are disclosed. The transceiver is adapted to detect the level amplitude of a received analog signal, adjust an amplification factor adaptively according to the detecting result to make the level amplitude of the received analog signal which has been amplified reach a same output level amplitude, perform an analog-to-digital conversion and a codec process, and transmit the signal to a MAC layer of the Ethernet. The transceiver is further adapted to amplify the level of a signal to be transmitted to a coax network and output the signal. The amplification factor is determined according to a maximum attenuation loss between coaxial terminals. In the present invention, an interaction between an Ethernet access point and a coaxial terminal and an interaction between coaxial terminals are carried out, which makes the CSMA/CD MAC layer of the Ethernet be adopted in an application environment of radio and television coax network.

### FIELD OF THE INVENTION

The present invention relates to Ethernet transmission technology, and particularly to a coax network based Ethernet transceiver and an Ethernet transmission method.

### BACKGROUND OF THE INVENTION

In a conventional fiber coaxial network (HFC) of a Community Antenna Television (CATV), TV programs from the front are transmitted to fiber coaxial terminals around subscribers in a TV network via fibers (under normal circumstances, a fiber coaxial terminal covers 300 to 500 subscribers around). TV signals are converted from optical signals to electrical signals at the fiber coaxial terminal, and then transmitted to residents' homes through a coax distribution network and via residential buildings. With the growth of demand on new bidirectional transmission services (for example, interactive digital television, broadband services such as data, voice, video and other multimedia communications implemented in a CATV network), the CATV network, which is only capable of transmitting signals in one direction, needs to carry out bidirectional services. A primary problem encountered is bidirectional reconstruction, which is a threshold to be stride when the CATV network is required to develop from a single function to multi-functions and from a radio and television network to an information network.

The Ethernet becomes a preferred choice of the bidirectional reconstruction of the HFC since the Ethernet has advantages such as simple, low cost and easy to expand. However, unlike a bus-based coax Ethernet with almost no attenuation or a point-to-point twisted-pair Ethernet network, the coax distribution network for supporting broadcast or TV has relatively large constant attenuation during transmission between an access point and a coaxial terminal and also between coaxial terminals. The attenuation characteristics of the transmission include the following two aspects:

1) The Attenuation Characteristics Between a Building Access Point and a Coaxial terminal

Please refer to FIG. 1, which is a diagram illustrating the structure of a network from the access point to coaxial terminals in a conventional CATV coax distribution network. As shown in FIG. 1, there is a building amplifier in each residential building. The building amplifier is adapted to amplify TV signals to compensate the attenuation of signals in transmission. It is supposed that a 6-floor residential building has 6 units, each unit has 12 doors. A TV signal amplified by the building amplifier is first transmitted to a 6-branch distributor by which the energy of the TV signal is averagely distributed to the 6 units. A branch of the TV signal is further divided by 2-branch splitters set on every floor of a unit and distributed to residents' homes (coaxial terminals) of two doors on every floor. In order to ensure that the amplitudes of the TV signals transmitted to the homes or doors are equal (because the amplitude of a signal received by a TV of each family needs to be equal to one another), the splitters set on different floors may have different attenuation amplitudes. For example, since the signal is generally transmitted from the first floor to the sixth floor and the signal transmitted to the first floor does not need to be transmitted through splitters and cables on the subsequent floors, the splitter on the first floor should be set a larger attenuation amplitude, for example generally 14 db attenuation, and the splitter on the second floor should be set a smaller attenuation amplitude, for example 12 db, and so on. In this way, though the TV signal travels into 12 families through different distances and different paths via a same coax distribution network, the attenuation of a same TV signal source transmitted from an access point to each coaxial terminal equals to one another.

Specifically, the TV signal amplified by the building amplifier is first transmitted to a 6-branch distributor by which the energy of the TV signal is divided averagely into 6 units. In each unit, a 2-branch splitter is set on each floor by which the TV signal is distributed to two families of the same floor. Then, the attenuation of the network is about 31 dB. Theoretically, the attenuation is calculated by adding the following parts: a 6-branch distributor (9 dB), 5 splitters on different floors, a 2-branch distributor on the sixth floor (14 dB), and a coax line (10 dB, calculated in accordance with the attenuation in a high frequency of 100 MHz) with a length about 50 meters (35 meters in the corridor and 15 meters in the room), and 33 dB is the adding result. Generally the attenuation is less than 31 dB in actual project. In other words, the output of the building amplifier is 100 dBuv (dB micro-volts) and the receiving amplitude of the TV at the subscriber end is 69 dBuv.

2) The Attenuation Characteristics Between Coaxial Terminals

Between different coaxial terminals in the CATV coax distribution network, since numbers of branch devices (distributors or splitters) traveled by signals communicated between two coaxial terminals are different, the attenuations of signals are different. The attenuation between coaxial terminals is at least 25 dB, or up to about 60 dB. Specifically, the attenuation (equivalent to a mutual isolation parameter of a splitter) between two coaxial terminals coupled to a same splitter varies approximately from 25 dB to 30 dB. The attenuation between two coaxial terminals coupled to different splitters, which is equivalent to a reverse isolation parameter adding a branch loss parameter, varies approximately from 40 dB to 60 dB.

In view of the above two attenuation characteristics, when applying Ethernet transmission protocol in a coax network, especially in case that a Carrier Sense Multiple Access/Collision Detection (CSMA/CD) protocol is applied at the MAC layer of the Ethernet, not only interaction between an Ethernet access point and a coaxial terminal is needed, but also interactions between coaxial terminals are needed. In other words, the interaction between the Ethernet access point and the coaxial terminal needs to overcome an attenuation of about 311 dB, and the interactions between coaxial terminals need to overcome an attenuation ranged from 25 dB to 60 dB.

Ethernet physical layer access chips in the market have some specifications including 10/100M self-adaptive, GE (Gigabit Ethernet), 10 GE (10 Gigabit Ethernet) and so on. The primary function of these chips is to complete physical layer encoding, digital-to-analog conversion, clock recovery and analog amplification. These chips structurally include an external interface (analog signal), as well as an interface to the MAC layer (digital signal).

Please refer to FIG. 2, which illustrates the structure of a physical layer device in a conventional Ethernet transceiver. As shown in FIG. 2, an analog interface unit 110 and an analog-to-digital/digital-to-analog (AD/DA) unit 120, a codec unit 130 and a MAC layer interface unit 140 are successively connected in series. In the receiving direction, an analog-to-digital conversion is performed by the AD/DA unit 120 on a received signal input from the analog interface unit 110 for converting an analog signal into a digital signal. Afterwards, the digital signal is coded and decoded by the codec unit 130 for extracting MAC layer data information from a physical layer coded data stream. Then the MAC layer data information is output after a MAC layer interface processing performed by the MAC layer interface unit 140. Here, the AD/DA unit 120 performs the analog-to-digital/digital-to-analog conversion in accordance with a standard transmission voltage and a standard receiving reference level specified in IEEE 802.3.

The Ethernet is based on twisted pair transmission. Take 100 meters as an example of transmission distance, the attenuation of the twisted pair at 20 MHz is only 8 dB. In case that the transmitting level of a transceiver of an Ethernet signal access point remains unchanged, if a transmitter of the transceiver of the access point or a coaxial terminal transmits signals with the standard transmission voltage in accordance with IEEE 802.3 and a receiver receives signals according to the standard receiving reference level, the accuracy of decoding by the receiver may be affected due to relatively great attenuations between the access point and the coaxial terminal and also between the coaxial terminals caused by the usage of splitting devices in the coax distribution network, and the receiver can not receive signals transmitted through the coax distribution network. Therefore it is essential to reconstruct the physical layer chip in the transceivers of the Ethernet access point and the coaxial terminal.

### SUMMARY OF THE INVENTION

In view of the above to-be-solved problem about the transmission of physical layer signals, an object of the present invention is to transmit baseband Ethernet signals using a conventional coax tree network, and to achieve a point to multi-point transmission of the baseband Ethernet signals in a conventional TV coax network when attenuations of the signals are big by reconstructing the physical layer transceivers at the transmitting end and at the receiving end.

Based on the above object, the present invention provides an Ethernet transceiver and an implementing method. The transceiver detects the level amplitude of a received analog signal, adjusts an amplification factor adaptively according to the detecting result, performs an analog-to-digital conversion and a codec process, and transmits the signal to a MAC layer of the Ethernet. The transceiver further amplifies the level of a signal to be transmitted to a coax network and outputs the signal. The amplification factor is determined according to a maximum attenuation loss between coaxial terminals.

The present invention further provides a computer device, which includes a software performing the Ethernet receiving method, and a hardware cooperating with the software.

It can be seen from the above technical scheme that the present invention makes use of a conventional tree coax network to transmit Ethernet baseband signals. The present invention adopts a new Ethernet transmission method to support point to multipoint transmission of the Ethernet baseband signals on a conventional TV coax network in which signals are attenuated by coax splitters and distributors. The present invention enables interactions between the Ethernet access point and coaxial terminals and between coaxial terminals, so that the CSMA/CD MAC layer of the Ethernet can be adopted in application environments of a radio and television coax network. In addition, the present invention eliminates signal distortion caused by inter-symbol interference in a transmission line and interferences between transmission lines.

Therefore, a good many opportunities are provided to the deploitation of value-added services in radio and television and also to the increment of existing network resources. Especially, the cost of such bidirectional reconstruction is very low.

### BRIEF DESCRIPTION OF DRAWINGS

FIG. 1 is a schematic diagram illustrating the structure of a network from a building access point to coaxial terminals in a conventional cable TV coax distribution network;

FIG. 2 is a schematic diagram illustrating the structure of a physical layer device (i.e., a chip) of a conventional Ethernet transceiver;

FIG. 3 is a schematic diagram illustrating the structure of an Ethernet transceiver according to an embodiment of the present invention;

FIG. 4 is a flow chart of an Ethernet transmission method in the coax network (in receiving direction) according to an embodiment of the present invention.

### DETAILED DESCRIPTION OF THE INVENTION

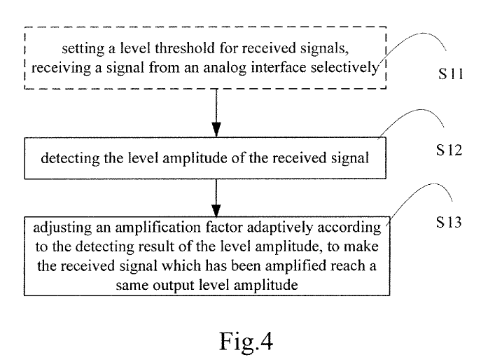

The structure of an Ethernet transceiver will be described in detail hereinafter in combination with the drawings. Further, by interconnecting transceivers of an Ethernet access point and a coaxial terminal or by interconnecting transceivers of two coaxial terminals, the MAC layer of the Ethernet can adopt Carrier Sense Multiple Access with Collision Detection (referred to as CSMA/CD for short) protocol for data transmission in the coax network. S in FIG. 4 denotes a step.

It is required in the Carrier Sense Multiple Access with Collision Detection protocol that each node is able to detect signals from one another to determine whether there is a collision in the transmission medium. The Carrier Sense Multiple Access with Collision Detection is a technique proposed for solving the collision problem caused by a simultaneous information transmission, whose working process is as follows: before sending a message, each node in a local area network (such as a workstation) detects a carrier signal in the transmission medium of the network in order to find out whether there is another workstation transmitting data. If not, a ready signal is reported to the workstation, and then the workstation begins to transmit data. If it is found by detecting the carrier signal that another workstation is transmitting data, the workstation will wait without sending any message. Therefore, once a coaxial terminal for multiple TV subscribers in the coax distribution network detects a signal sent by another coaxial terminal, a collision in the transmission medium is determined, which enables the usage of the MAC layer protocol CSMA/CD of the Ethernet in the TV coax distribution network.

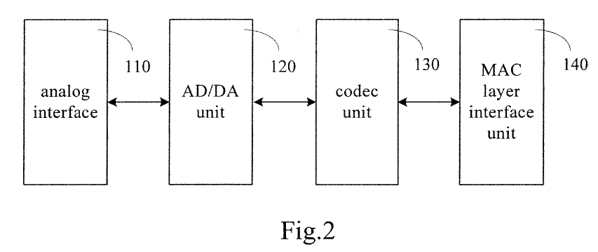

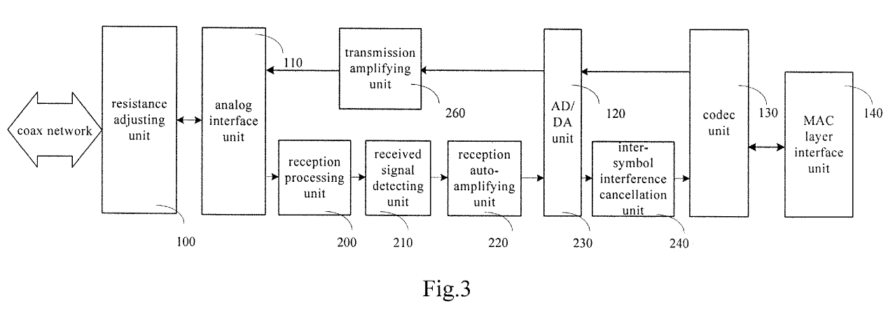

Please refer to FIG. 3, FIG. 3 is a schematic diagram illustrating the structure of an Ethernet transceiver according to an embodiment of the present invention. An analog interface unit 110 of the Ethernet transceiver coupled to a coax is applicable to an Ethernet access point and coaxial terminals in the coax distribution network. Similar to the structure in FIG. 2, a physical layer chip in the transceiver includes an analog interface unit 110, an AD/DA (analog-to-digital/digital-to-analog) unit 120, a codec unit 130, and a MAC layer interface unit 140. The functions of the units in FIG. 3 are the same with the functions of the units in FIG. 2.

What is different to FIG. 2 is a transmission amplifying unit 260 is inserted between the analog interface unit 110 and the AD/DA (analog-to-digital/digital-to-analog) unit 120 in the transmitting direction of the signal. The transmission amplifying unit 260 is adapted to amplify the level of a transmitting signal output to the analog interface unit 110. Also, transmitters of the transceivers of the access point or the coaxial terminals can transmit signals with a transmission voltage whose output amplitude is lager than that specified in IEEE 802.3.

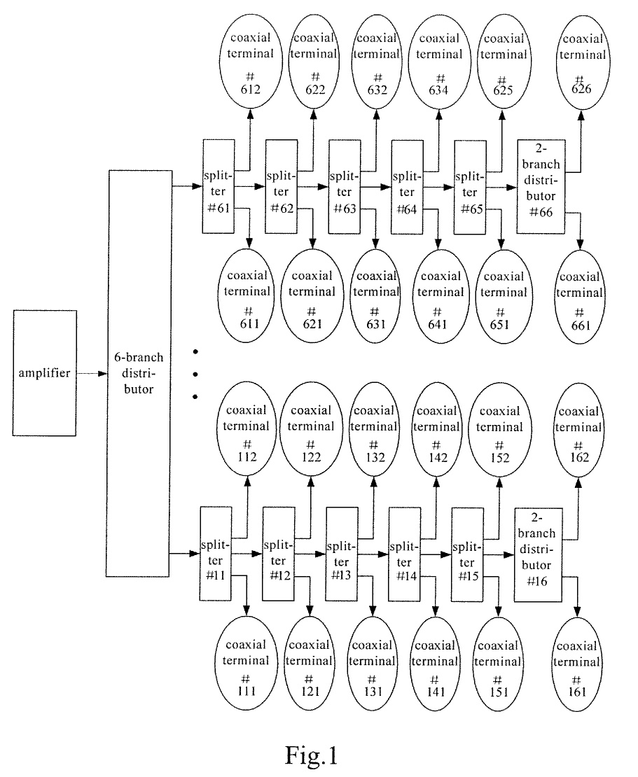

Please refer to FIG. 1 again, in accordance with the calculation described in the background of the invention, the attenuation loss between the access point and a coaxial terminal in the coax distribution network is a fixed value (such as 20 dB). Likewise, the attenuation loss between a coaxial terminal and the access point is also 20 dB. However the attenuation losses between coaxial terminals are different (for example, ranged from 25 dB to 60 dB). Therefore, in order to realize the interactions between the Ethernet access point and each coaxial terminal, as well as the interactions between coaxial terminals, it is required that receivers must be able to receive signals in a larger dynamic range in the receiving direction.

The dynamic range of receiving is calculated as follows: obtaining an upper limit of the dynamic range by comparing a minimum attenuation between two coaxial terminals coupled to a same splitter (that is, one of the two coaxial terminals is capable of receiving data sent by the other coaxial terminal) with attenuations between each coaxial terminal and the access point; and obtaining a lower limit of the dynamic range according to the attenuation between two different coaxial terminals coupled to different splitters. Thus a dynamic receiving range of the received signal can be represented by the difference between the upper limit and the lower limit of the dynamic range. For example, when the upper limit of the dynamic receiving range of the present embodiment is an input voltage attenuation of 25 dB and the lower limit is an input voltage attenuation of 60 dB, the dynamic receiving range is 35 dB.

In accordance with a formula for calculating the attenuation based on voltage (in dB as a unit):

Voltage attenuation amplitude=20 lg(Vx/Vo) Formula 1

wherein Vx refers to an input voltage, and Vo refers to an output voltage.

It can be concluded from the above-mentioned formula that: in case the voltage attenuation amplitude is 20 dB, Vx/Vo=10; while in case the voltage attenuation amplitude is 60 dB, Vx/Vo=100. And in a 50 meters long coax distribution network without attenuations of splitters, since the voltage attenuation amplitude of the network is only about 2 dB, the corresponding Vx/Vo=1.25.

Therefore, assuming that the input voltage of the access point Vx=1V, in the case of 2 dB, the output voltage is 0.79V. Similarly, in the case of 20 dB, the output voltage is 0.1V; and in the case of 60 dB, the output voltage is 0.001V.

In the above circumstances, if the input voltage amplitude of the Ethernet signal access point is 1V, the amplitude of the signal reaching each coaxial terminal should be 0.1V. Similarly, if the output amplitude of the signal transmitted by each coaxial terminal is 1V, the input amplitude of the signal reaching the Ethernet is also 0.1V; while the output amplitude of the signal reaching another coaxial terminal is up to 0.056V or down to 0.001V. Therefore, the amplification factor of the transmission amplifying unit 260 is determined according to a maximum attenuation loss between coaxial terminals. The receiver is enabled to receive a signal with a maximum attenuation (such as 60 dB) transmitted through the coax distribution network. Preferably, the amplification factor of the transmission amplifying unit 260 enables the receiver to receive a voltage signal according to the IEEE 802.3 standard without affecting the accuracy of decoding.

If the minimum amplitude of a signal that the physical layer chip can detect is 0.5V, the output voltage of the physical layer chip should be amplified to 500V at the input end in accordance with the formula Vx/Vo=1000 under the circumstance that the voltage attenuation amplitude is 60 dB. Therefore amplifiers are needed at the output ends of the physical layer chips of the access point and the coaxial terminals to increase the transmitting amplitude of the signal.

In the signal reception direction, a reception processing unit 200, a received signal detecting unit 210 and a reception auto-amplifying unit 220 are inserted in order between the analog interface unit 110 and the AD/DA (analog-to-digital/digital-to-analog) unit 120.

The reception processing unit 200 selectively receives a signal from the analog interface unit 110 by setting a level threshold for the received signal. The level threshold for the received signal is determined according to a maximum attenuation characteristic factor between coaxial terminals. The reception processing unit 200 filters signals with a voltage value lower than the maximum attenuation loss between coaxial terminals to avoid unnecessary interferences.

The received signal detecting unit 210 detects the level amplitude of the received signal transmitted from the analog interface unit 110. Since the amplitudes of signals received by the Ethernet access point or the coaxial terminal from different transmitting nodes (an Ethernet access point or a coaxial terminal) are different, the dynamic range of reception can be from 20 dB to 60 dB. Therefore differentiated amplifications to the signal amplitudes of different received signals are needed.

The reception auto-amplifying unit 220 is coupled to the received signal detecting unit 210 in the receiving direction, and adjusts the amplification factor adaptively according to a detecting result of the level amplitude. Here, many approaches in the related art can be adopted to adjust the amplification factor of the reception auto-amplifying unit 220 adaptively. For example, as to the received signals with different input amplitudes, an adaptive amplification approach is adopted to make output amplitudes of different received signals reach a same amplitude after amplification. In another adaptive amplification approach, the received signals are amplified to the extent that they can be accurately converted by the AD/DA unit 120, e.g., the amplitudes of the received signals can be raised from the input amplitudes to amplitudes higher than a base reference level of the AD/DA unit 120. The above-mentioned approaches of providing different amplification factors to different received signals can make the amplified signals meet the processing requirements of the AD/DA unit 120, and ensure correct conversion of analog signals with low amplitudes into digital signals.

Specifically, in the present invention, the receiving end first detects the level amplitude of the received input signal received from the analog port 110, and then determines an amplification factor for the subsequent reception auto-amplifying unit 220 according to the amplitude of the input signal, which enables subsequent units (such as the analog-to-digital/digital-to-analog conversion unit 120) in the physical layer chip of the receiver to perform a unified process.

In the present embodiment, the signal output by the reception auto-amplifying unit 220 is transmitted to the analog-to-digital/digital-to-analog conversion unit 120 which is adapted to perform conversions between analog signals and digital signals.

For example, if the received signal is transmitted from the Ethernet access point to a coaxial terminal and the input voltage amplitude of the Ethernet signal access point is 5V, the amplitude of the signal reaching the coaxial terminal should be 0.5V under the circumstance that the attenuation is 20 dB. And if the reference level (i.e., a criteria to judge 0 or 1) of the analog-to-digital/digital-to-analog conversion unit 120 of the receiver is 0.5V, the amplification factor of the receiver can be set to 2 to ensure correct processing of the analog-to-digital/digital-to-analog conversion unit 120 on the signal with a voltage amplitude of 0.5V. In this case, through the amplification by the reception auto-amplifying unit 220, the signal sent by the Ethernet access point which has been attenuated by the coax distribution network can meet the processing requirement of the analog-to-digital/digital-to-analog conversion unit 120 without changing the base reference level of the AD/DA (analog-to-digital/digital-to-analog) unit 120. Thus the analog-to-digital/digital-to-analog conversion unit 120 can obtain accurate digital signals from analog signals with lower amplitudes.

Please refer to FIG. 4, FIG. 4 is a flow chart illustrating the Ethernet transmission method in the coax network (in the receiving direction) according to a first embodiment of the present invention. The transmission method according to the present embodiment includes the following steps:

Step S11: setting a level threshold to a received signal, and selectively receiving a signal from the analog interface unit;

Step S12: detecting the level amplitude of the received signal;

Step S13: adjusting an amplification factor adaptively according to the detecting result of the level amplitude, such as making the received signal which has been amplified reach a same output amplitude or amplifying the received signal to the extent that it can be accurately converted by an AD/DA unit.

The method further includes the following steps after step S13:

Step S14: performing an analog-to-digital conversion according to a reference level to the received signal which has been processed;

Step S15: eliminating a crosstalk signal in the received signal which has been performed the analog-to-digital conversion.

In the present embodiment, in order to eliminate signal distortion caused by inter-symbol interference in a transmission line and interference between transmission lines, in the signal receiving direction, an inter-symbol interference cancellation unit 240 adapted to eliminate a crosstalk signal in the received signal which has been performed the analog-to-digital conversion is coupled to the analog-to-digital/digital-to-analog conversion unit 120. Since the inter-symbol interference cancellation unit 240 can adopt techniques from the prior art, no repetition of these techniques will be given.

In addition, since a twisted-pair can be taken as a differential parallel load of 100 ohm while a coax is a single-end load of 75 ohm, the load needs to be changed to 75 ohm when designing a PHY chip. As shown in FIG. 3, the analog interface unit 110 is coupled to the coax through a resistance adjusting unit 100. The resistance adjusting unit 100 adjusts the load of the physical layer to 75 ohm. It can also be designed that the resistance adjusting unit 100 is set behind the analog interface unit 110.

From the above description of the embodiments, a person skilled in the art would clearly understand that the present invention can be implemented by software in combination with necessary general hardware platform, or implemented in hardware. The former implementation is a better choice in some cases. Based on this understanding, the present invention or the part of the present invention contributing to the prior art can essentially be presented in the form of a software product. This computer software product stored in a storage medium includes a number of instructions which make a computer (can be a personal computer, a server, or a network equipment, etc.) implement the methods according to the embodiments of the present invention.

To be noted, the foresaid summary and the embodiments of the invention are intended to prove actual application of the technical scheme provided by the present invention. The above descriptions should not be interpreted as limitations to the protection scope of the present invention. Modifications, equivalents and improvements can be made by persons killed in the art within the spirit and principles of the present invention. The protection scope of the present invention is determined by the claims attached.

1. An Ethernet transceiver, adapted to transmit Ethernet data in a coax distribution network, comprising: an analog interface unit and an analog-to-digital/digital-to-analog unit; and
further comprising:
a received signal detecting unit, adapted to detect the level amplitude of a received signal transmitted from the analog interface unit;
a reception auto-amplifying unit coupled to the received signal detecting unit and the analog-to-digital/digital-to-analog unit respectively, adapted to adjust an amplification factor adaptively according to the detecting result of the level amplitude detected by the received signal detecting unit, and amplify the received signal according to the amplification factor before sending the amplified signal to the analog-to-digital/digital-to-analog unit.

2. The Ethernet transceiver according to claim 1, further comprising:
a reception processing unit coupled to the analog interface unit and the received signal detecting unit, adapted to select a signal received from the analog interface unit by setting a level threshold for the received signal.

3. The Ethernet transceiver according to claim 2, wherein the level threshold is determined according to a maximum attenuation loss between coaxial terminals.

4. The Ethernet transceiver according to claim 1, further comprising:
a resistance adjusting unit coupled to the analog interface unit, adapted to adjust payloads of a physical layer.

5. The Ethernet transceiver according to claim 1, further comprising:
an inter-symbol interference cancellation unit coupled to the analog-to-digital/digital-to-analog unit and a codec unit respectively, adapted to eliminate a crosstalk signal in the received signal which has been given an analog-to-digital conversion.

6. The Ethernet transceiver according to claim 1, wherein the reception auto-amplifying unit is adapted to adjust the amplification factor for enabling the level amplitude of the received signal to reach a same output amplitude after amplification.

7. The Ethernet transceiver according to claim 1, wherein the reception auto-amplifying unit is adapted to adjust the amplification factor for enabling the level amplitude of the received signal to be higher than a base reference level of the analog-to-digital/digital-to-analog unit after amplification.

8. The Ethernet transceiver according to claim 1, further comprising:
a transmission amplifying unit coupled to the analog interface unit and the analog-to-digital/digital-to-analog unit respectively, adapted to amplify the level of a transmission signal to be output to the analog interface unit; wherein the amplification factor of the transmission amplifying unit is determined according to a maximum attenuation loss between coaxial terminals.

9. An Ethernet transmission method, applied in a device comprising an analog interface unit, a MAC layer interface unit, a codec unit and an analog-to-digital/digital-to-analog unit;
the method comprising:
detecting the level amplitude of a received signal transmitted from the analog interface unit;
adjusting an amplification factor adaptively according to the detecting result of the level amplitude, and amplifying the received signal according to the amplification factor before sending the amplified signal to the analog-to-digital/digital-to-analog unit;
outputting the signal to the MAC layer interface unit through the analog-to-digital/digital-to-analog unit and the codec unit.

10. The Ethernet transmission method according to claim 9, wherein adjusting an amplification factor and amplifying the received signal according to the amplification factor comprises: amplifying the received signal to reach a same output level amplitude.

11. The Ethernet transmission method according to claim 9, wherein adjusting an amplification factor and amplifying the received signal according to the amplification factor comprises: amplifying the received signal to reach an amplitude higher than a base reference level of the analog-to-digital/digital-to-analog unit.

12. The Ethernet transmission method according to claim 9, further comprising:
amplifying the output signal transmitted from the MAC layer interface unit through the codec unit and the analog-to-digital/digital-to-analog unit according to an amplification factor determined according to a maximum attenuation loss between coaxial terminals; and
transmitting the amplified signal to the coax network through the analog interface unit.

13. The Ethernet transmission method according to claim 9, further comprising:
selecting a signal received from the analog interface unit by setting a level threshold for the received signal before detecting the level amplitude of the received signal transmitted from the analog interface unit.

14. The Ethernet transmission method according to claim 13, wherein the level threshold is determined according to a maximum attenuation loss between coaxial terminals.

15. The Ethernet transmission method according to claim 9, further comprising:
adjusting payloads of a physical layer before detecting the level amplitude of the received signal.

16. The Ethernet transmission method according to claim 9, further comprising:
eliminating a crosstalk signal in the received service signal which has been given an analog-to-digital conversion, before coding/decoding the received signal.

17. A computer device, comprising:
a software performing an Ethernet transmission method according to claim 9; and
a hardware cooperating with the software.
